(19) United States
(12) Patent Application Publication
(10) Pub. No.: US 2008/0133289 A1
(43) Pub. Date: Jun. 5, 2008

(54) Model Based License Counting

(75) Inventors: David Armour, Redmond, WA (US); Marc Shepard, Redmond, WA (US); Camron Smith, Redmond, WA (US); Mark Sterin, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/566,773

(22) Filed: Dec. 5, 2006

(51) Int. Cl. G06Q 10/00

(52) U.S. Cl. 705/7; 705/1; 705/30

(57) ABSTRACT

In a network, such as an enterprise network, license related data of products of client devices are collected, aggregated, and reported uniformly. The client devices may be part of a managed node, and the license data may be sent (collected) by a central device, such as a server. Furthermore, administration of the products may also be performed.

### BACKGROUND

Tracking and counting licenses across an enterprise is required for various reasons such as compliance validation, assessing the number of licenses purchased in relation to the number of licenses actually being used, etc. Licenses come in many forms and can be based on any number of license units. Each product has its own peculiarities in the way its license unit should be counted. Additionally, some products can be licensed in multiple ways. This may lead to confusion and dissatisfaction on the customer side and can often lead to over-buying or under-buying of licenses.

### SUMMARY

This summary is provided to introduce simplified concepts of model based license counting, which is further described below in the Detailed Description. This summary is not intended to identify essential features of the claimed subject matter, nor is it intended for use in determining the scope of the claimed subject matter.

In an embodiment, software products such as applications or operating systems resident in server or work stations or devices are detected, license related data of the applications is identified and collected. An aggregation is performed as to the collected license related data.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

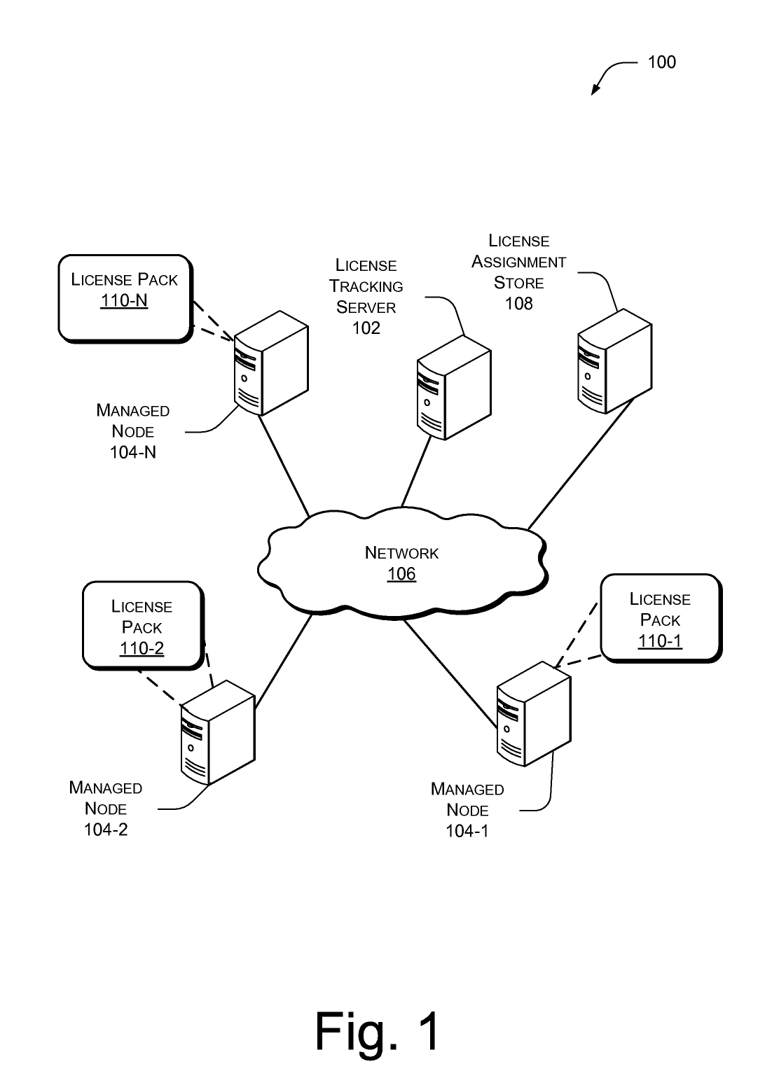

FIG. 1 is an illustration of an exemplary license tracking system.

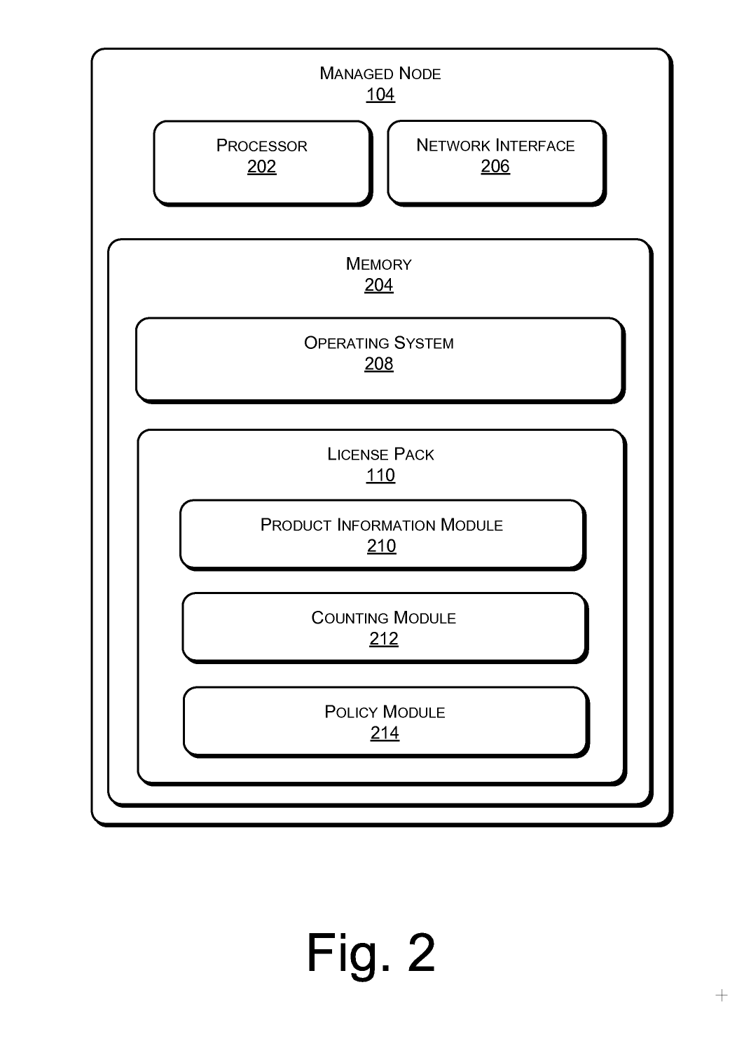

FIG. 2 is an exemplary implementation of a managed node.

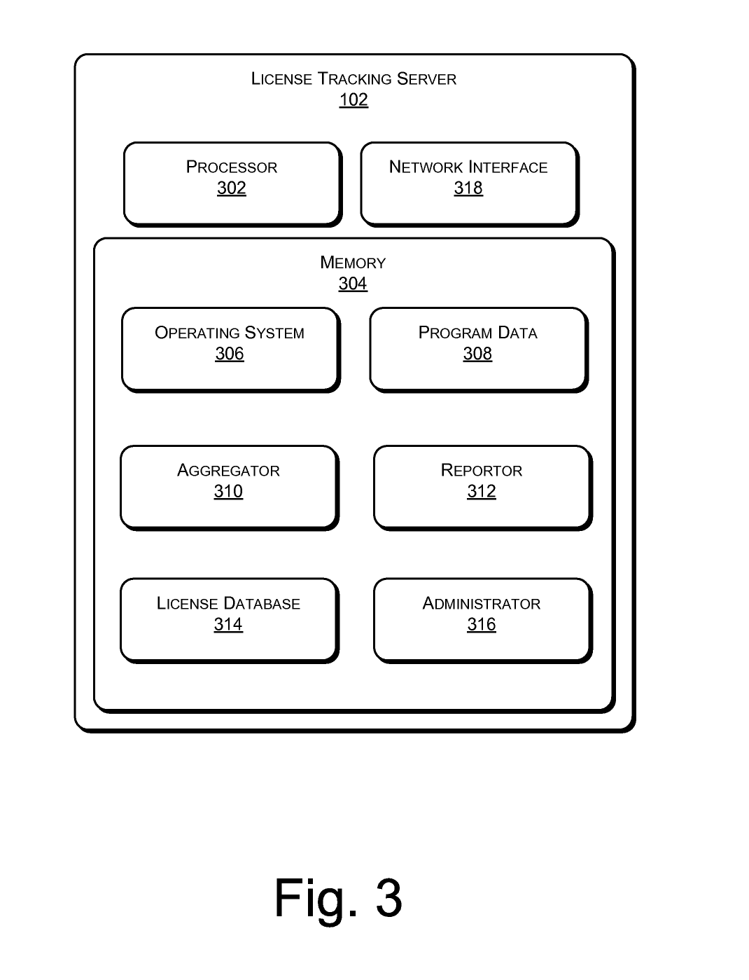

FIG. 3 is an exemplary implementation of a license tracking server.

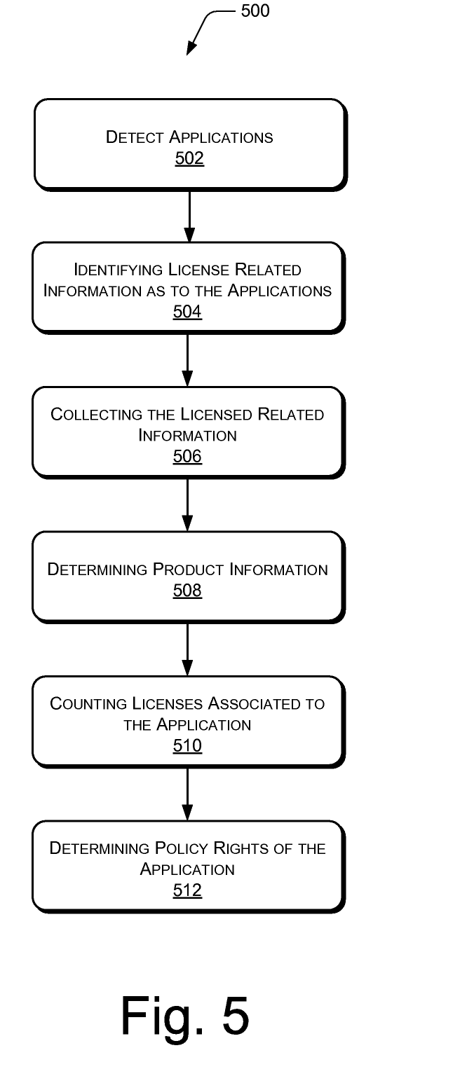

FIG. 5 is a flow diagram for aggregating license information in a system. a flow diagram of a spoofing

FIG. 5 is a flow diagram for detecting applications and collecting licensed related information of the applications.

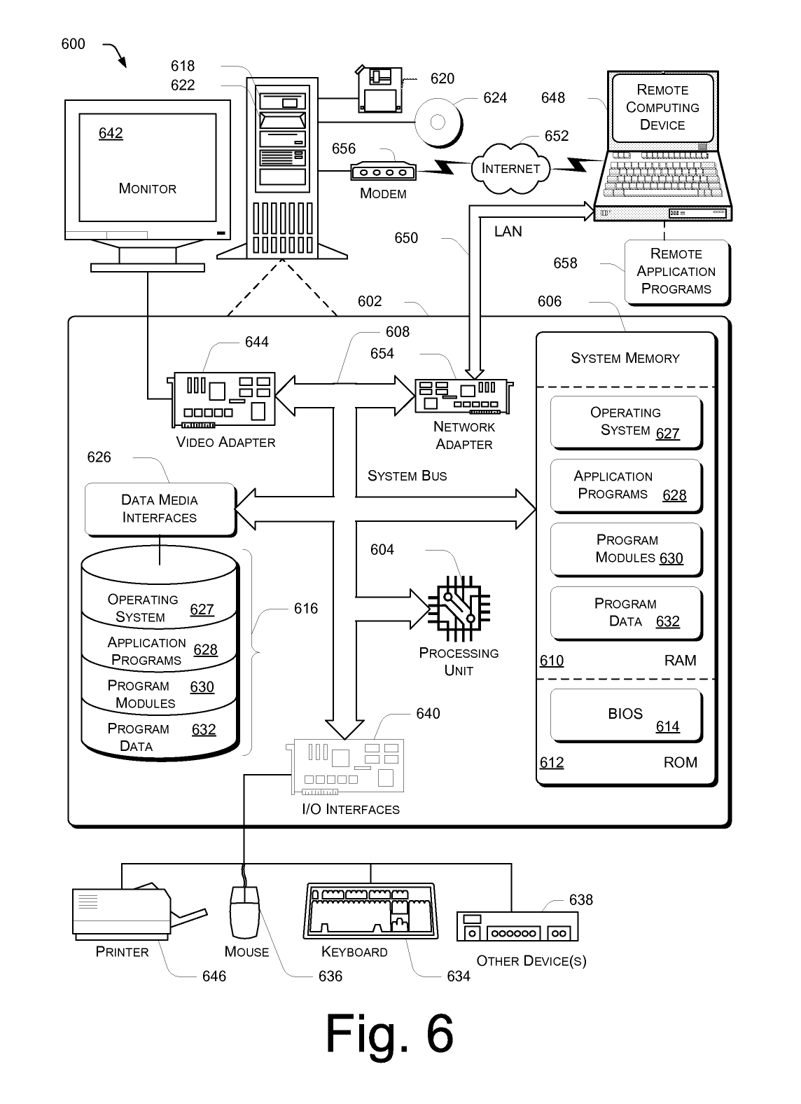

FIG. 6 is an exemplary computer environment.

### DETAILED DESCRIPTION

The following disclosure describes systems and methods for model based license counting. While aspects of described systems and methods for model based license counting can be implemented in any number of different computing systems, environments, and/or configurations, embodiments are described in the context of the following exemplary system architectures.

Systems and methods for license tracking using model based license counting are described. The model for each product (application) is defined in component referred to as a license pack. A framework for collecting information from the license packs across an organization to implement license tracking is also described.

The license pack detects the application and gathers all information that affects the price of the application, for example, version, language, edition, distribution channel, etc. In addition, the license pack identifies unit(s) of measure and their combination(s) on which the license is based and definitive location(s) on the system to measure the unit(s). Further, the license pack determines any use-rights associated with the license that defines a policy for how the product should be used.

### Exemplary License Management System

FIG. 1 shows an exemplary license management system 100 for a distributed network. The system 100 includes a license tracking server 102 associated with one or more managed nodes 104 (104-1, 104-2 . . . 104-N) over a network 106. The system 100 may further include a license assignment store 108. The license assignment store 108 may be associated directly with the license tracking server 102, or may be associated with the license tracking server 102 over the network 106.

The license tracking server 102 may be a dedicated server or an existing server that is assigned to take on the role of a license tracking server. For example, an existing server could be one of a Microsoft® Operations Manager (MOM) server, System Management Server (SMS), System Center Essentials (SCE) server, Windows® Update Server (WSUS), etc., that is assigned to take on the role of the license tracking server 102. The managed nodes 104 include all server (or workstation or device) nodes that are accountable to the license tracking server 102. A managed node 104 may include a single server (or workstation or device) or a set of servers, include directory services servers The network 106 may include, for example, one or more of the following: domain controller, local area network, wide-area network, wireless network, optical network, an enterprise network etc. An enterprise network includes hardware, software and media connecting information technology resources of an organization. A typical enterprise network is formed by connecting network clients, servers, a number of other components like routers, switches, etc., through a communication media.

In one implementation, one or more of the managed nodes respectively employ license packs 110 (110-1, 110-2 . . . 110-N) to automatically detect applications and identify license related information. This information may be used by the license tracking server 102 for various purposes such as accounting, reporting and compliance validation.

In an exemplary implementation of the license tracking server 102, the license tracking server 102 collects license data from the managed nodes 104 using the license packs 110. The license tracking server 102 performs aggregation of the license data collected from each of the license packs 110 across an enterprise, reports the aggregation, provides administration functions and maintains a central database to store aggregated data. The administrative functions may include functions such as pushing updated versions of a license pack, compliance validation, scheduling aggregation, providing exclusion areas such as for maintenance, etc. License tracking servers may federate, or in other words form hierarchical topology where each license tracking server is responsible for a subset of managed node. For example, a department in an organization) and information for the whole enterprise still could be accessed from a single license tracking server.

For compliance validation, the license tracking server 102 may import license statements such as a list of license statements of products that were purchased from a common source or multiple sources, for example from an Microsoft® Licensing Statetement (MLS) web services. License statements for existing applications may also be manually entered via an administrative console or may be automatically scanned from license stores, like a Software Protection Platform in Windows Vista (SPP), on the managed nodes. The license tracking server 102 may then compare the aggregated license data with the license statements and check for compliance. The administration console may generate alerts when license compliance terms are violated.

An exemplary managed node 104 and an exemplary license pack 110 are further described below with reference to FIG. 2. An exemplary license tracking server 102 is then described with reference to FIG. 3.

### Exemplary Managed Node

FIG. 2 shows a managed node 104 according to an embodiment. Accordingly, the managed node 104 includes one or more processors 202 coupled to a memory 204. Such processors could be for example, microprocessors, microcomputers, microcontrollers, digital signal processors, central processing units, state machines, logic circuitries, and/or any devices that manipulate data based on operational instructions. The processor 202 is configured to fetch and execute computer-program instructions stored in the memory 204. Such memory 204 includes, for example, one or more combination(s) of volatile memory (e.g., RAM) and non-volatile memory (e.g., ROM, Flash etc.). The memory 204 stores computer executable instructions and data for model based license counting. A network interface 206 provides the capability of the managed node 104 to interface with the license tracking server 102 or the license assignment store 108 or other managed nodes 104 via network 106.

In one implementation, the memory 204 stores operating system 208 that provides a platform for executing applications on the managed node 104. The memory 204 further stores a license pack 110 capable of automatically detecting applications and identifying license related information. In an exemplary implementation, the license pack 110 uses model based accounting methods for each application (product) to collect license related information for the application. In one embodiment, the license pack 110 is an XML document that defines how license tracking may be implemented for a product.

In an exemplary implementation, the license pack 110 includes a product information module 210, a counting module 212 and a policy module 214. The product information module 210 determines information related to the application, such as the application type, and all information that affects the price of the application, for example, version, language, edition, distribution channel, etc. The counting module 212 identifies one or more units of measure on which the license is based and a definitive location on the system to measure the unit(s). The counting module 212 also includes rules to combine the units of measure to determine a chargeable unit. The policy module 214 identifies any use-rights associated with the license to define a policy for how the application can be used.

In one embodiment, the product information module 210 may use existing infrastructure such as the Windows Software Protection Platform (SPP). For example, the product information module 210 may include a SPP provider, an Internet Information Services (IIS) provider, a Client Access License (CAL) counting application program interface (API) and a scan provider. In this embodiment, the SPP provider gathers data from a software licensing API (SLAPI, aka SPP). The IIS provider gathers client web service data from IIS logs. The CAL counting API allows logging of CAL usage. A scan provider leverages an update agent such as a Windows® update agent to scan for the presence of products with a per-install license such as Windows® Office®.

In one implementation, the counting module 212 identifies one or more units of measure that may be used to determine the number of licenses. The counting module 212 identifies definitive location(s) in the managed node 104 where the identified units may be counted from. The counting module 212 also describes rules to combine the identified units. The rules may be arithmetic and/or logical expressions used to determine a chargeable unit from the identified units. In one embodiment the counting module 212 utilizes existing applications to determine product usage such as windows management interface (WMI), software licensing store (SLS), client access license log (CAL), IIS, event log, etc.

In one implementation, the policy module 214 identifies a license policy associated with the application using an address/method that identifies where the applications policy information is located. In one embodiment, the application policy information (i.e., usage rights document) defines local constraints (e.g., legal use rights) as to how the purchased software may be used. For example, the usage rights document may limit the number of virtual machines per server that can run simultaneously without additional payment, or the number of administrators that can log in, etc. This information may be further used by the license tracking server 102 to validate compliance of the license(s). In an exemplary embodiment, the policy module 214 may include a file system, an autolog, a system API etc.

### Exemplary License Tracking Server

FIG. 3 shows a license tracking server 102 according to an embodiment. Accordingly, the license tracking server 102 includes one or more processors 302 coupled to a memory 304. Such processors 302 could be, for example, microprocessors, microcomputers, microcontrollers, digital signal processors, central processing units, state machines, logic circuitries, and/or any devices that manipulate data based on operational instructions. The processors 302 are configured to fetch and execute computer-program instructions stored in the memory 304. Such memory 304 includes, for example, one or more combination(s) of volatile memory (e.g., RAM) and non-volatile memory (e.g., ROM, Flash etc.).

In an exemplary implementation, the memory 304 stores operating system 306 that provides a platform for executing applications on the managed nodes 104 and program data 308 that stores information generated during the execution of various programs. The memory 304 further includes an aggregator 310, a reporter 312, a license database 314, and an administrator 316. The license tracking server 102 may also include a network interface 318 that enables the license tracking server 102 to operate over the network 106.

The license tracking server 102 also compares the data with existing data in the license database 314 and also with data present in the license assignment store 108. The license tracking server 102 may also monitor change in license agreement such as expansion of use rights, addition of license units, etc. that may occur, for example as technology develops. The license tracking server 102 can then push new license packs 110 to managed nodes if the product's license model evolves.

In addition, a license assignment tool such as a license assignment store 108 may be used to assign each of the licenses to users. Results of data collection/aggregation generated earlier can be matched/used by the license assignment tool.

The license tracking server 102 can register itself in a place (i.e., common or known server/computer) so that users (i.e., client computers, management nodes) can find the license tracker server 102. The license packs 110 can be installed and updated automatically as a license changes and is clarified. The license tracking server 102 may be able host data for multiple enterprises (e.g., companies). Systems may be implemented such that each enterprise (company) is able to see its own license data alone. In addition, an active directory (AD) marker can be used to allow managed nodes to automatically discover the license tracking server 102 in order to roll up license data.

### Exemplary Methods

Exemplary methods for model-based license counting are described. These exemplary methods may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may instructions may be located in both local and remote computer storage media, including memory storage devices.

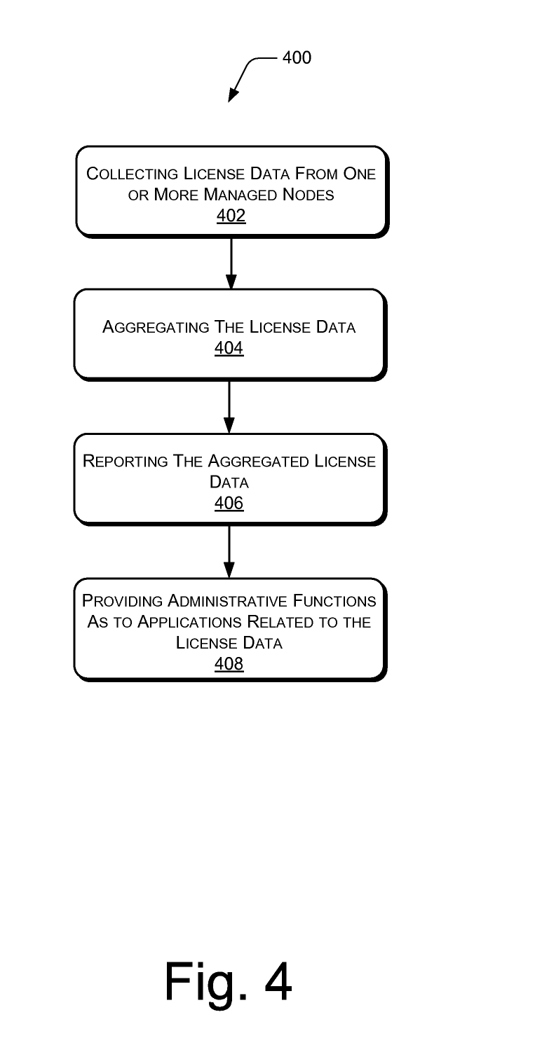

FIG. 4 illustrates an exemplary method 400 for aggregating license information in a system. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 402, licensing data or licensing information is collected from one or more management nodes, such as management nodes 104 in a system or enterprise network, such as system 100. This may be performed by a central server, such as license tracking server 102. The collecting may also be performed through installed license packs, such as license packs 110.

At block 404, the licensing data collected from the managed nodes is aggregated at a central location. The aggregation may be performed by the license tracking server 102. The aggregation may be performed when all licensing data is collected.

At block 406, the aggregated licensing data is reported. The reporting may be to a different device, such as server or computer, than the licensing tracking server 102, or may be reported to a particular user or network management personnel.

At block 408, administrative functions are provided directed to applications of the managed nodes. As described above, examples of administrative functions include pushing updated versions of a license pack, compliance validation, scheduling aggregation, and providing exclusion areas such as for maintenance.

FIG. 5 illustrates an exemplary method 500 for detecting products and collecting licensed related information of the products. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 502, products resident in one or more client computers, and in certain embodiments server computers, of a managed node are detected. Detection of the products may be performed by a license pack installed on each of the client computers.

At block 504, license related information or license related data, as to the products are identified or tracked. The license related information can include all information that affects the price of the product, for example, version, language, edition, distribution channel, etc. This information may be used for various purposes such as accounting, reporting and compliance validation.

At block 506, the license related information is collected. The collection may be through model based accounting methods for each application (product).

At block 508, product information is determined related to the product, for example, such as product type, and all information that affects the price of the product, such as version, language, edition, distribution channel.

At block 510, license(s) associated to the product are counted. The counting can include identifying where identified units may be counted from and describing rules to combine the identified units. The rules may be arithmetic and/or logical expressions used to determine a chargeable unit from the identified units.

At block 512, license policy rights of the application are determined. License policy may be associated with the application using an address/method that identifies where the applications policy information is located. Information in the policy can define local constraints (e.g., legal use rights) as to how the purchased software may be used.

### Exemplary Computer Environment

FIG. 6 illustrates an exemplary general computer environment 600, which can be used to implement the techniques described herein, and which may be representative, in whole or in part, of elements described herein. The computer environment 600 is only one example of a computing environment and is not intended to suggest any limitation as to the scope of use or functionality of the computer and network architectures. Neither should the computer environment 600 be interpreted as having any dependency or requirement relating to any one or combination of components illustrated in the example computer environment 600.

Computer environment 600 includes a general-purpose computing-based device in the form of a computer 602. Computer 602 can be, for example, a desktop computer, a handheld computer, a notebook or laptop computer, a server computer, a game console, and so on. The components of computer 602 can include, but are not limited to, one or more processors or processing units 604, a system memory 606, and a system bus 608 that couples various system components including the processor 604 to the system memory 606.

The system bus 608 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 602 typically includes a variety of computer readable media. Such media can be any available media that is accessible by computer 602 and includes both volatile and non-volatile media, removable and non-removable media.

The system memory 606 includes computer readable media in the form of volatile memory, such as random access memory (RAM) 610, and/or non-volatile memory, such as read only memory (ROM) 612. A basic input/output system (BIOS) 614, containing the basic routines that help to transfer information between elements within computer 602, such as during start-up, is stored in ROM 612. RAM 610 typically contains data and/or program modules that are immediately accessible to and/or presently operated on by the processing unit 604.

Computer 602 may also include other removable/non-removable, volatile/non-volatile computer storage media. By way of example, FIG. 6 illustrates a hard disk drive 616 for reading from and writing to a non-removable, non-volatile magnetic media (not shown), a magnetic disk drive 618 for reading from and writing to a removable, non-volatile magnetic disk 620 (e.g., a “floppy disk”), and an optical disk drive 622 for reading from and/or writing to a removable, non-volatile optical disk 624 such as a CD-ROM, DVD-ROM, or other optical media. The hard disk drive 616, magnetic disk drive 618, and optical disk drive 622 are each connected to the system bus 608 by one or more data media interfaces 626. Alternately, the hard disk drive 616, magnetic disk drive 618, and optical disk drive 622 can be connected to the system bus 608 by one or more interfaces (not shown).

The disk drives and their associated computer-readable media provide non-volatile storage of computer readable instructions, data structures, program modules, and other data for computer 602. Although the example illustrates a hard disk 616, a removable magnetic disk 620, and a removable optical disk 624, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 616, magnetic disk 620, optical disk 624, ROM 612, and/or RAM 610, including by way of example, an operating system 627, one or more application programs 628, other program modules 630, and program data 632. Each of such operating system 627, one or more application programs 628, other program modules 630, and program data 632 (or some combination thereof) may implement all or part of the resident components that support the distributed file system.

A user can enter commands and information into computer 602 via input devices such as a keyboard 634 and a pointing device 636 (e.g., a “mouse”). Other input devices 638 (not shown specifically) may include a microphone, joystick, game pad, satellite dish, serial port, scanner, and/or the like. These and other input devices are connected to the processing unit 604 via input/output interfaces 640 that are coupled to the system bus 608, but may be connected by other interface and bus structures, such as a parallel port, game port, or a universal serial bus (USB).

A monitor 642 or other type of display device can also be connected to the system bus 608 via an interface, such as a video adapter 644. In addition to the monitor 642, other output peripheral devices can include components such as speakers (not shown) and a printer 646 which can be connected to computer 602 via the input/output interfaces 640.

Computer 602 can operate in a networked environment using logical connections to one or more remote computers, such as a remote computing-based device 648. By way of example, the remote computing-based device 648 can be a personal computer, portable computer, a server, a router, a network computer, a peer device or other common network node, and the like. The remote computing-based device 648 is illustrated as a portable computer that can include many or all of the elements and features described herein relative to computer 602.

Logical connections between computer 602 and the remote computer 648 are depicted as a local area network (LAN) 650 and a general wide area network (WAN) 652. Such networking environments are commonplace in offices, enterprise-wide computer networks, intranets, and the Internet.

When implemented in a LAN networking environment, the computer 602 is connected to a local network 650 via a network interface or adapter 654. When implemented in a WAN networking environment, the computer 602 typically includes a modem 656 or other means for establishing communications over the wide network 652. The modem 656, which can be internal or external to computer 602, can be connected to the system bus 608 via the input/output interfaces 640 or other appropriate mechanisms. It is to be appreciated that the illustrated network connections are exemplary and that other means of establishing communication link(s) between the computers 602 and 648 can be employed.

In a networked environment, such as that illustrated with computing environment 600, program modules depicted relative to the computer 602, or portions thereof, may be stored in a remote memory storage device. By way of example, remote application programs 658 reside on a memory device of remote computer 648. For purposes of illustration, application programs and other executable program components such as the operating system are illustrated herein as discrete blocks, although it is recognized that such programs and components reside at various times in different storage components of the computing-based device 602, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

The above-described methods and system describe model based license counting. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
collecting licensing data of one or more products;
aggregating the licensing data at a central location;
reporting the aggregating of the license data.

2. The method of claim 1, wherein the collecting is from one or more management nodes.

3. The method of claim 1, wherein the collecting is through from one or more clients.

4. The method of claim 1, wherein the aggregating is performed when all licensing data from one or more management nodes is collected.

5. The method of claim 1, wherein the reporting is sent to a different device than the device performing the method of claim 1.

6. The method of claim 1 further comprising administrative functions as to the one or more products.

7. The method of claim 5, wherein the administrative functions include one or more of the following: pushing updated versions of a license pack, compliance validation, scheduling aggregation, and providing exclusion areas such as for maintenance.

8. A method comprising:
detecting applications in one or more client computers of a managed node;
identifying license related data as to the applications; and
collecting the license related data.

9. The method of claim 8, wherein the detecting is performed by license packs installed in the one or more client computers.

10. The method of claim 8, wherein the identifying is of the license related data, includes license related data information affecting the price of the applications.

11. The method of claim 8, wherein the collecting is through model based accounting methods for each of the applications.

12. The method of claim 8 further comprising determining product information related to the applications.

13. The method of claim 8 wherein the product related information includes one or more of the following: product type and information affecting price of the product.

14. The method of claim 1 further comprising counting the products.

15. The method of claim 1 further comprising determining license policy rights of the products.

16. A managed node comprised of:
a processor;
a memory accessed by the processor;
a license pack configured as part of the memory or separate from the memory, and controlled by the processor, wherein the license pack is configured to detect applications and license related information.

17. The managed node of claim 16, wherein the license pack uses model based accounting methods for each application.

18. The managed node of claim 16, wherein the license pack is an XML document.

19. The managed node of claim 16, wherein the license pack comprises one or more of the following: a product information module, a counting module, and a policy module.

20. The managed node of claim 19, wherein the counting module identifies one or more units of measure used to determine a number of licenses.
